(19) United States
(12) Patent Application Publication
(10) Pub. No.: US 2026/0051785 A1
(43) Pub. Date: Feb. 19, 2026

(54) VOLUMETRICALLY CONSTRAINED COMPOUND ROTORS FOR FLYWHEEL ELECTRIC STORAGE SYSTEMS AND NUMERICAL MODELING PROCESSES FOR THE PRODUCTION THEREOF

(71) Applicant: RotorVault, Inc., Glendora, CA (US)

(72) Inventor: Robert Javier Villegas, Glendora, CA (US)

(21) Appl. No.: 19/300,428

(22) Filed: Aug. 14, 2025

Related U.S. Application Data
(60) Provisional application No. 63/682,952, filed on Aug. 14, 2024.

(51) Int. Cl. H02K 7/02

(52) U.S. Cl. CPC H02K 7/025; H02K 2207/00

(57) ABSTRACT

A flywheel energy system includes a set of compound rotor assemblies, wherein each compound rotor assembly includes a set of disks each defined by a radial profile. The radial profile includes: a rim-transitional region defining a circumferential rim and a rim transition; an attachment-driven region and a clearance-driven transition; and a Laval-like region connecting the clearance-driven transition to the rim transition. Between each pair of adjacent disks, an attachment subassembly includes: an alignment pin arranged within a pair of adjacent central bores of the pair of adjacent disks; and a pair of attachment flanges each fastened to an opposite attachment flange in the pair of attachment flanges via a set of inter-flange fasteners and fastened to a disk in the pair of adjacent disks via a set of disk-flange fasteners.

### CROSS REFERENCE TO RELATED APPLICATIONS

This application claims priority to the U.S. Provisional Application No. 63/682,952, filed on 14 Aug. 2024, which is incorporated in its entirety by this reference.

### TECHNICAL FIELD

This invention relates generally to the field of flywheel electric storage systems and, more specifically, to new and useful volumetrically constrained compound rotor assemblies and numerical modeling processes for the production thereof in the field of flywheel electric storage systems.

### BRIEF DESCRIPTION OF THE FIGURES

FIG. 1 is a schematic representation of one variation of a flywheel electric storage system (FESS).

FIG. 2 is a schematic representation of one variation of the system.

FIG. 3 is a schematic representation of one variation of a compound rotor assembly of the FESS.

FIG. 4 is a schematic representation of one variation of a disk of the compound rotor assembly.

FIG. 5 is a schematic representation of one variation of a disk of the compound rotor assembly.

FIG. 6 is a schematic representation of one variation of an attachment subassembly of the compound rotor assembly.

FIG. 7 is a flowchart representation of one variation of a process for defining a radial profile of the disk.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

Generally, the term “can,” as utilized herein, indicates an action or attribute of the system, which may or may not be executed by or be applicable to the system, depending on the implementation or embodiment of the system.

Generally, the term “include,” as utilized herein, can mean “comprise,” “consist of,” or “consist essentially of” and is not restricted to any one of the above interpretations throughout.

Generally, the term “set,” as utilized herein, can represent a single instance or multiple instances of an associated object. Descriptors such as “first,” “second,” “third,” etc., as utilized herein, do not imply a sequence or order unless otherwise specified but do imply separate instances of the associated object.

Generally, the terms “planar,” “symmetric,” “coaxial,” “parallel,” “perpendicular,” and other terms characterizing the relative position or precisely defining characteristics of physical objects, as utilized herein, describe substantial adherence to the aforementioned concepts within mechanical tolerances. For example, if one component is “coaxial” with another, this indicates that the central axes of these components are aligned within a predefined tolerance. However, these components may define slightly different central axes relative to each other (e.g., due to play in an interface between these components, elasticity, and/or thermal expansion).

Generally, the term “Laval-like,” as utilized herein, describes a radial profile of a disk of the compound rotor assembly that includes a geometry substantially similar to the geometry of an ideal Laval disk. More specifically, the shape of an ideal Laval disk is derived by applying an isostress criterion to the material of the disk.

Generally, the term “monolithic,” as utilized herein, describes a single piece of material (e.g., a disk) lacking an axial through-hole.

### 1. Flywheel Disk

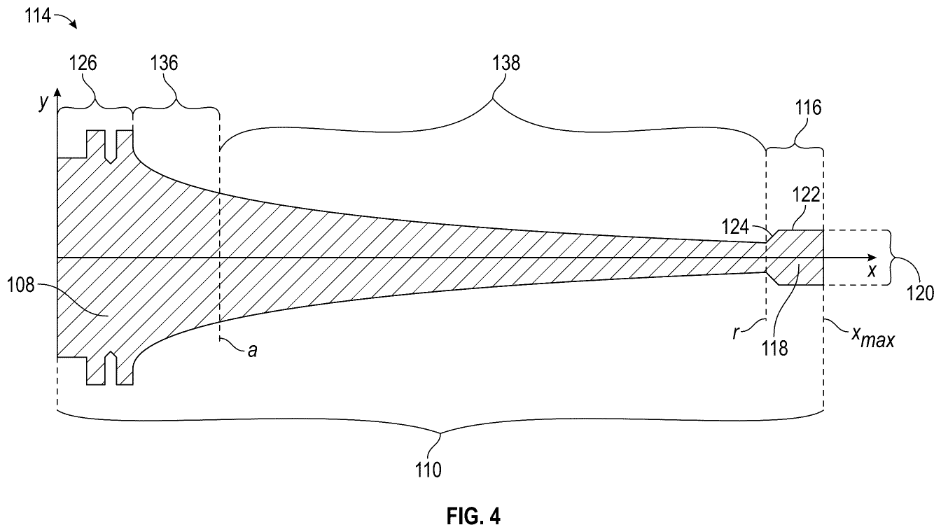

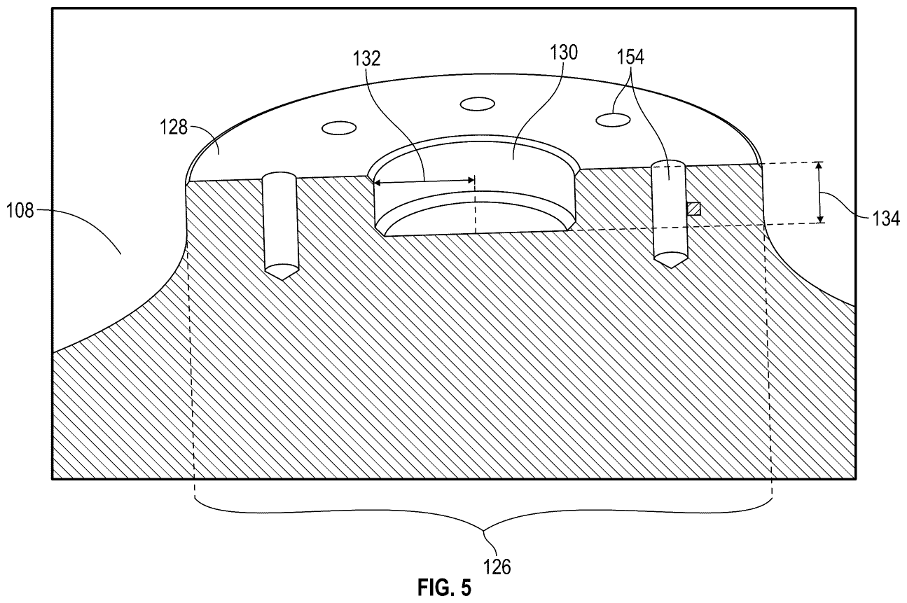

Generally, as shown in FIGS. 4 and 5, a flywheel disk (e.g., of a flywheel energy storage system) is characterized by a disk radius 110 and a radial profile 114. The radial profile 114 includes a rim-transitional outer region 116 defining: a circumferential rim 118 about the circumference of the disk 108 characterized by a rim thickness 120 and a circumferential surface 122; and a rim transition 124 inscribing the circumferential rim 118. The radial profile 114 further includes an attachment-driven inner region defining: an annular surface 128 substantially concentric with a central bore 130 and substantially parallel to a rotational plane of the disk 108, the central bore 130 characterized by a central bore radius 132 and a central bore depth 134 relative to the annular surface 128; and a clearance-driven transition 136 circumscribing the annular surface 128. Finally, the radial profile 114 includes a Laval-like intermediate region 138 connecting the clearance-driven transition 136 to the rim transition.

### 2. Compound Rotor Assembly

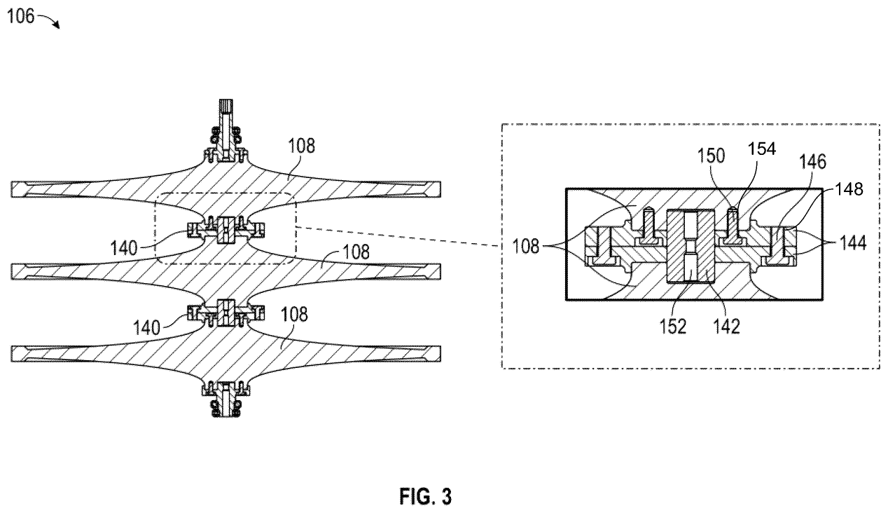

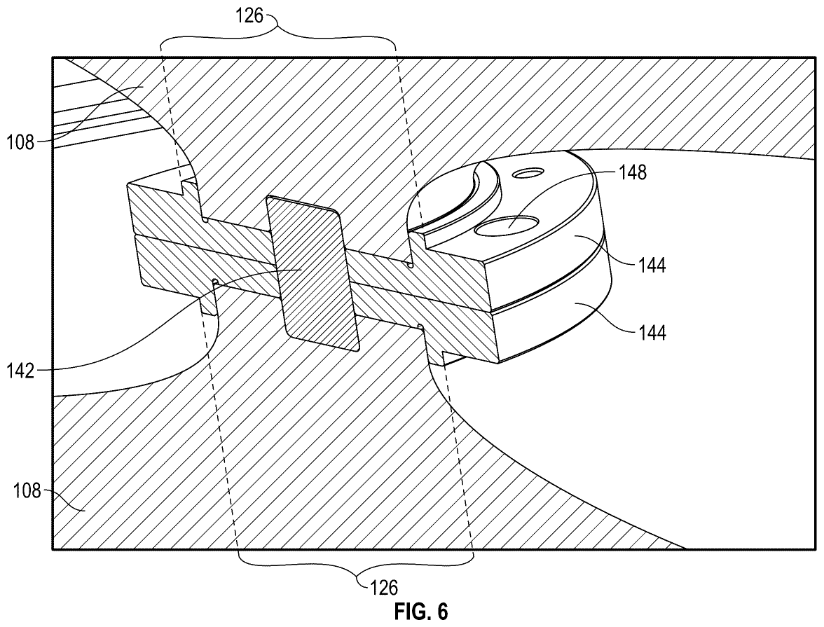

Generally, as shown in FIG. 3, a compound rotor assembly 106 includes: a set of disks 108, wherein each disk 108 is substantially coaxial, rotationally symmetric, and monolithic; and a set of attachment subassemblies 140. Between each pair of adjacent disks 108 in the set of disks 108, as shown in FIG. 6, the compound rotor assembly 106 includes an attachment subassembly 140 in a set of attachment subassemblies 140. Each attachment subassembly 140 includes: an alignment pin arranged within a pair of adjacent central bores 130 of the pair of adjacent disks 108; and a pair of attachment flanges circumscribing the alignment pin, each attachment flange 144 in the pair of attachment flanges fastened to an opposite attachment flange 144 in the pair of attachment flanges via a set of inter-flange fasteners 146 and fastened to a disk 108 in the pair of adjacent disks 108 via a set of disk-flange fasteners 150. The system 100 further includes a set of motor-generator units 156, each motor-generator unit 156 in the set of motor-generator units 156: coupled to a compound rotor assembly 106 in the set of compound rotor assemblies 106; and configured to transmit and extract rotational energy from the compound rotor assembly 106.

### 3. Flywheel Energy Storage System

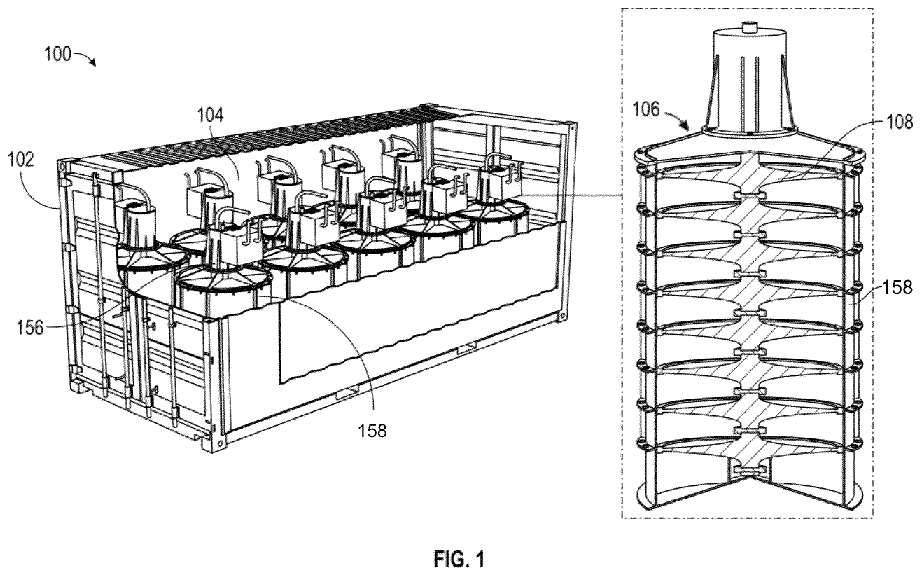

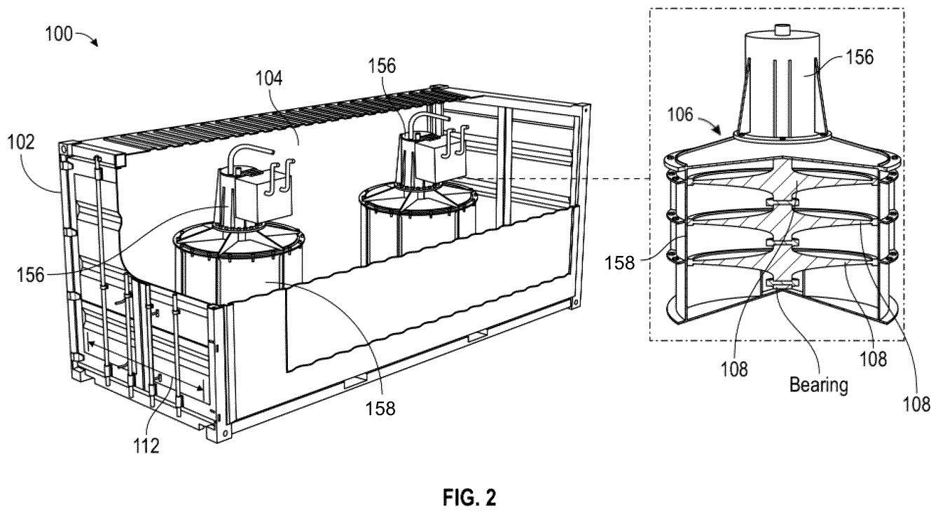

As shown in FIGS. 1 and 2, a flywheel energy storage system 100 (FESS) includes: a system housing 102 defining a deployment volume 104; a set of compound rotor assemblies 106 arranged within the deployment volume 104; and a set of motor-generator units 156 arranged within the deployment volume 104.

### 4. Applications

Generally, the compound rotor assembly 106 is utilized as a flywheel in a flywheel energy storage system (hereinafter “FESS” and/or “the system”). More specifically, the compound rotor assembly 106 exhibits a high specific energy (i.e., greater than 50 watt-hours per kilogram) and a high overall system energy density (i.e., greater than 16,000 watt-hours per cubic meter) compared to state-of-the-art rotors constructed from isotropic materials. Additionally, because the compound rotor assembly 106 includes multiple coaxial disks 108, the compound rotor assembly 106 is axially extensible (via the addition of shaped disks 108) to occupy available axial space while maintaining rotational stability, thereby facilitating deployment within various predefined volumes (e.g., standard shipping containers). Furthermore, the compound rotor assembly 106 is characterized by design features such as a circumferential rim 118 and a well-defined dimensional reference that reduce manufacturing costs and enhance durability.

Additionally, the radial profile 114 that defines the shape of the compound rotor assembly 106 can be generated based on a radial space constraint 112 for the compound rotor assembly 106 or for each individual disk 108 within the compound rotor assembly 106 to improve energy storage density and/or throughput (e.g., discharge rate) within radially constrained deployment volumes 104. More specifically, each disk 108 of the compound rotor assembly 106 can define a numerically refined radial profile 114 that is characterized by an approximately maximum shape factor within manufacturing constraints based on the radial space constraint 112 and the material properties of the disk's material. Thus, in some implementations, the compound rotor assembly 106 shape is defined based on its intended deployment volume 104 and/or application.

In one specific application, the compound rotor assembly 106 defines a shape based on the volumetric constraints (radial and axial constraints) of a shipping container, which facilitates deployment of the system 100 including the compound rotor assembly 106 via typical shipping methods. Thus, by maximizing energy density within an easily deployable volume, the compound rotor assembly 106 can improve the economics of FESS deployment.

In one implementation, the system 100 can be configured for increased energy storage capacity. For example, the disks 108 of this implementation can be characterized by a large radius (e.g., two feet or more), enabling the compound rotor assemblies 106 of this implementation to store an increased amount of electrical energy (compared to a smaller radius disk 108) as rotational energy via the rotation of the large disks 108. The large-radius disk 108 implementation can therefore be used as a backup power supply, such as for a data center. More specifically, the system 100 can be connected to the data center and “charge” (e.g., increase rotational speed of the disks 108) via an electrical circuit of the data center. During a grid blackout, the system 100 can “discharge” power to the data center by: decreasing the rotational speed of the disks 108; converting the lost rotational energy to electrical energy via the set of motor-generator units 156; and supplying the electrical energy to the data center. Thus, the compound rotor assembly 106 improves the feasibility of the system as a grid energy storage or time-shift system by lowering the levelized cost of storage to below those of contemporary battery electric storage systems.

In another implementation, the system 100 can be configured for increased throughput to improve the rate of charge and discharge of the system. For example, in this implementation, the disks 108 of the compound rotor assemblies 106 can be characterized by a smaller radius than those of the example above (e.g., less than two feet). The smaller-radius disks 108 enable the motor-generator units 156 of this implementation to quickly spin up and spin down the disks 108 to charge and discharge the system. In this implementation, the system 100 can include more total disks than the storage capacity-driven implementation to exhibit increased throughput without significant loss of storage capacity. Therefore, this implementation can absorb and emit energy surges with low latency (e.g., millisecond latency) and be used to smooth grid instabilities or protect the grid from variable loads.

### 5. System

Generally, as shown in FIGS. 1 and 2, the system 100 is configured to: store energy by rotating a set of disks 108 within a set of compound rotor assemblies 106; and transmit energy by reducing the rotational speed of the compound rotor assemblies 106 via the set of motor-generator units 156. For example, the system 100 can: receive an input amount of electrical energy; transform the electrical energy into rotational energy by powering a set of motor-generator units 156 via the input amount of electrical energy to rotate a set of disks 108 of the set of compound rotor assemblies 106; and discharge approximately the input amount of electrical energy via the set of motor-generator units 156 slowing the rotation of the set of disks 108 within the set of compound rotor assemblies 106. Generally, as shown in FIGS. 1 and 2, the system 100 includes: a system housing 102; a set of (e.g., one or more) compound rotor assemblies 106 arranged within the system housing 102; and a set of motor-generator units 156, each motor generator unit associated with a compound rotor assembly 106 in the set of compound rotor assemblies 106.

In one implementation, the system 100 can provide power storage. For example, the system 100 can function as a backup battery for a load that benefits from uninterrupted power. For example, the system 100 can: receive electrical power from the grid to effectively “charge” the system 100 (e.g., rotate the compound rotor assemblies 106 at a target maximal rotational speed); and at a later time “discharge” electrical energy to the load in response to an outage by removing rotational energy from the set of compound rotor assemblies 106.

In another implementation, the system 100 can provide grid stability similar to a synchronous condenser. For example, the system 100 can: absorb surges of power from the grid (e.g., by transforming the electrical energy of the surge into rotational energy to rotate the set of compound rotor assemblies 106); and provide power to the grid such as during a grid brownout or sag (e.g., by discharging rotational energy of the compound rotor assemblies 106 by slowing the compound rotor assemblies 106 rotational speed via the motor-generator unit).

### 5.1 System Housing

Generally, the system 100 includes a system housing 102 configured to contain components of the system 100, including but not limited to the set of compound rotor assemblies 106 and the set of motor-generator units 156. The system housing 102 defines a deployment volume 104 characterized by internal dimensions of the system housing 102. In one implementation, the system housing 102 can be a standard shipping container defining a deployment volume 104 with dimensions including a length of twenty feet, a width of eight feet, and a height of eight and a half feet. However, the system housing 102 can be another container defining a suitable deployment volume 104 for the system 100.

In one implementation, the system housing 102 can include a set of electrical ports configured to connect the system 100 to an electrical circuit or grid. The set of electrical ports enables power transmission between the electrical circuit or grid and the motor-generator units 156 of the system.

In one implementation, the arrangement of the components of the system 100 within the system housing 102 is based on one or more radial and axial space constraints and clearances between select components of the system. In one implementation, the system 100 defines: a first motor-generator unit clearance between the motor-generator unit 156 and a top surface of the compound rotor housing 158; and a second motor-generator unit clearance between the motor-generator unit 156 and a ceiling of the deployment volume 104, such that motor-generator unit 156 can be installed and maintained without removal of the compound rotor housing 158 from the system housing 102. In one implementation, the system 100 defines: a first compound rotor housing clearance between each compound rotor housing 158 within the deployment volume 104 to enable access to each compound rotor housing such as for maintenance; and a second compound rotor housing clearance between the set of disks 108 of each compound rotor assembly 106 and an interior surface of the compound rotor housing 158 to prevent contact between the disks 108 and the compound rotor housing 158 during operation of the system 100. In one implementation, the radial space constraint includes the second compound rotor housing clearance between the set of disks 108 of each compound rotor assembly 106, and the axial space constraint includes: the first motor-generator unit clearance; the second motor-generator unit clearance; and the first compound rotor housing clearance. Therefore, the arrangement of the components of the system 100 within the deployment volume 104 of the system housing 102 is selected based on the radial space constraint(s) and axial space constraint(s).

### 5.2 Compound Rotor Assembly

Generally, the system 100 includes one or more compound rotor assemblies 106 arranged within the deployment volume 104. Each compound rotor assembly 106 includes: a compound rotor housing 158; a set of disks 108 arranged within the compound rotor housing 158; a set of attachment subassemblies 140; and a set of bearings configured to support the set of disks 108 along a fixed axis. In one implementation, a compound rotor assembly 106 includes a set of coaxial, rotationally symmetric, and monolithic (i.e., without a central through-bore) disks 108 attached via a set of attachment subassemblies 140 between each pair of adjacent disks 108.

The compound rotor assembly 106 includes an attachment subassembly 140 between each pair of adjacent disks 108 in the set of disks 108. The attachment subassembly 140 includes: an alignment pin 142 arranged within a pair of adjacent central bores 130 of the pair of adjacent disks 108; and a pair of attachment flanges 144 circumscribing the alignment pin 142, each attachment flange 144 in the pair of attachment flanges 144 fastened to an opposite attachment flange 144 in the pair of attachment flanges 144 via a set of inter-flange fasteners 146 and fastened to a disk 108 in the pair of adjacent disks 108 via a set of disk-flange fasteners 150.

### 5.3 Motor-Generator Units

Generally, the system 100 includes a set of motor-generator units 156, each motor-generator unit 156 in the set of motor-generator units 156: coupled to a compound rotor assembly 106; and configured to input and extract rotational energy from the compound rotor assembly 106. Each motor-generator unit 156 is configured to modulate the rotational energy of the set of disks 108 via the principle of electromagnetic induction. For example, as the rotor rotates, the magnetic field changes, thereby inducing an electrical current within a coiled wire of the motor-generator unit. A controller of the system 100 can operate the motor-generator unit 156 to increase or decrease an amount of energy stored within the system 100 as rotational energy. Therefore, the motor-generator unit 156 can convert kinetic energy of the compound rotor assembly 106 into electrical energy and convert electrical energy into kinetic energy of the compound rotor assembly 106.

### 6. Disks

Generally, the compound rotor assembly 106 of the system 100 includes a set of coaxial, rotationally symmetric, and monolithic (i.e., without a central through-bore) disks 108 attached to each other via a set of attachment subassemblies 140 between each pair of adjacent disks 108. More specifically, the shape of each disk 108 in the set of disks 108 is defined by a disk radius 110 and a radial profile 114 described in further detail below. The geometry of the set of disks 108 satisfies a set of manufacturing constraints that improve the manufacturability of the set of disks 108. Additionally, the set of disks 108 is simultaneously characterized by a high shape factor (e.g., greater than 0.7), which improves the energy storage capacity of each disk 108. Because the set of disks 108 contributes the majority of the mass of the compound rotor assembly 106, the aforementioned properties of the set of disks 108 enable these desirable properties, such as energy storage capacity for the entire compound rotor assembly 106.

In one implementation, the geometry of the set of disks 108 is selected or generated based on the deployment volume 104, a compound rotor housing 158 of the compound rotor assembly 106, minimum clearances between the edge of the set of disks 108 and the compound rotor housing, and minimum clearances between the outer surfaces of the compound rotor housing 158 and the deployment volume 104. Therefore, the deployment volume 104 and the compound rotor housing 158 can define radial space constraints 112 at various axial positions and axial space constraints at various radial positions. The deployment volume 104 can constrain the spatial dimensions of components of the system, including: a vacuum chamber encompassing the compound rotor assembly 106 (e.g., the compound rotor housing 158); the bearings that enable rotation of the disks 108 of the compound rotor assembly 106; and/or the motor-generator units 156.

In another implementation, the set of disks 108 is characterized by a single disk geometry shared by all disks 108 in the set of disks 108. This implementation enables more efficient mass production of multiple compound rotor assemblies 106, and may be appropriate in applications for which a single radial space constraint 112 is applicable along the entire axis of the compound rotor assembly 106. In another implementation, the set of disks 108 is characterized by multiple radii, and therefore, multiple different geometries, to satisfy varying radial space constraints 112 for the compound rotor assembly 106 along the axis of the compound rotor assembly 106. Thus, the uniformity of the set of disks 108 may vary based on the deployment volume 104 and the compound rotor housing 158.

In one implementation, the set of disks 108 is manufactured from a substantially uniform isotropic material, such as steel, aluminum, titanium, magnesium, or alloys thereof. In one example of this implementation, the set of disks 108 is manufactured from high-strength and/or high-toughness steel, such as Maraging steel or any other martensitic high-nickel (greater than 15% by mass) steel. Thus, the set of disks 108 can be manufactured from any high-strength and high-toughness isotropic material based on the intended application and cost constraints of the compound rotor assembly 106.

Generally, each disk 108 in the set of disks 108 is individually cast, forged, machined, and/or heat-treated to obtain a high-strength and uniform disk 108 of the isotropic material. In one implementation, prior to heat treatment, more detailed features of the disk 108, such as the central bore 130, the annular surface 128, and the precise curvature of the radial profile 114, are machined into the disk 108. Additionally, the disk 108 can be rotationally balanced via selective localized material removal by machining the outer rim. In this implementation, the central bore 130 of the disk 108 can act as a reference feature or datum for other features of the disk 108. Thus, in this implementation, the inner surface of the central bore 130 and the engagement of the central bore 130 with the alignment pin 142 control the coaxial alignment of the set of disks 108.

In one implementation, each disk 108 in the set of disks 108 is individually manufactured via closed-die forging. For example, each disk 108 can be manufactured by pressing a heated billet of material between two halves of a die defining a geometry corresponding to or based on the radial profile 114 of the disk 108. During closed-die forging, excess material may create necks at the seams of the die. After forging, these necks can be removed and the profile of the disk 108 refined via machining. Additionally or alternatively, the shape of each disk 108 can be achieved via any other manufacturing technique appropriate for the disk material.

### 6.1. Radial Profile

As shown in FIG. 4, each disk 108 in the set of disks 108 is characterized by a radial profile 114 that defines a rim-transitional outer region 116, an attachment-driven inner region 126, and a Laval-like intermediate region 138. More specifically, the rim-transitional outer region 116 defines: a circumferential rim 118 about the circumference of the disk 108 characterized by a rim thickness 120 and a circumferential surface 122; and a rim transition 124 inscribing the circumferential rim 118. The attachment-driven inner region 126 defines: an annular surface 128 substantially concentric with a central bore 130 and substantially parallel to a rotational plane of the disk 108 (the central bore 130 characterized by a central bore radius 132 and a central bore depth 134 relative to the annular surface 128); a set of disk-flange fastener bores 154 arranged radially about the central bore 130 (each disk-flange fastener bore 154 in the set of disk-flange fastener bores 154 configured to receive a disk-flange fastener 150); and a clearance-driven transition 136 circumscribing the annular surface 128. The Laval-like intermediate region 138 connects the clearance-driven transition 136 to the rim transition 124.

In implementations of the disk 108 that are symmetric about a plane of symmetry parallel to the rotational plane of the disk 108, the two-dimensional radial profile 114 of each disk 108 defines the geometry of the disk 108. However, in other implementations, the disk 108 can define an upper radial profile 114 and a lower radial profile. Thus, the geometry of the disk 108 is well represented by the radial profile.

In one implementation, the radial profile 114 is represented by a piecewise function that provides an axial dimension, y, for each radial dimension, x, less than or equal to the radial space constraint 112, xₘₐₓ, for the disk 108:

$$\begin{matrix}y = A ( x ) , [ 0 , a ] \\ y = L ( x ) , ( a , r ) \\ y = R ( x ) , [ r , {x}_{max} ] ,\end{matrix}$$

wherein A(x) represents the attachment-driven inner region 126, a represents the radial boundary of the attachment-driven inner region 126, L(x) represents the Laval-like intermediate region 138, R(x) represents the rim-transitional outer region 116, and r represents the radial boundary of the rim-transitional outer region 116.

Generally, A(x), L(x), and R(x) can themselves be defined as piecewise functions, spline functions, polynomials, or any combination thereof. Additional characteristics of each region are described in further detail below.

Generally, various aspects of the radial profile 114 can be designed (algorithmically or manually) based on a vector of mechanical properties of the disk 108 material, Pₘ, and a vector of manufacturing constraints, Cₘ. More specifically, Pₘ can include the disk material's density, tensile strength, Young's Modulus, fatigue strength, fracture toughness, thermal expansion coefficient, and/or any other material property. Additionally, Cₘ can include a maximum temperature gradient within the disk 108 during heat treatment, fastener thicknesses for the disk-flange fasteners 150, the expected shrinkage proportion during cooling, maximum post-heat treatment residual stresses within the disk 108, maximum tangential and radial stresses for the disk 108 at intended operational speeds, expected forces and torques (including vibrational forces) on the annular surface 128 at the disk 108-flange interface or between the center bore of the disk 108 and the alignment pin 142 of the attachment-subassembly, minimum machinable surface angles, and/or any other manufacturing constraint or boundary condition.

### 6.1.1. Rim-Transitional Outer Region

Generally, the rim-transitional outer region 116 of the radial profile 114 defines an outer rim of each disk 108 in the set of disks 108 that departs from an ideal Laval isostress profile to improve the manufacturability and durability of each disk 108 during transport. More specifically, the rim-transitional outer region 116 defines a circumferential rim 118 characterized by a rim thickness 120 and a circumferential planar surface. In particular, the rim-transitional outer region 116 defines a rim thickness 120 based on disk 108 material characteristics and manufacturing constraints. The circumferential rim 118 defines a radial width xₘₐₓ−r sufficient for the heat treatment process of the disk 108 material. The circumferential planar surface also enables the disk 108 to be more easily balanced via selective milling of the circumferential planar surface to achieve a target balance quality grade. Additionally, the rim-transitional outer region 116 can define a tapering section connecting the circumferential rim 118 to the Laval-like intermediate region 138 without significant stress concentrations while reducing mass distributed at lower radial distances. In one implementation, the disk 108 is rotationally balanced via selective machining of the circumferential surface 122 of the rim. Thus, the rim-transitional outer region 116 represents a modification to an ideal Laval disk 108 shape to improve the manufacturability, durability, and deployability of the disk 108.

In one implementation, the rim-transitional outer region 116 defines an outer rim and tapering section of sufficient thickness and radial width to support the weight of the disk 108. In this implementation, the compound rotor assembly 106 can more easily be assembled from the set of disks 108 by improving the ability to transport the set of disks 108.

### 6.1.2. Attachment-Driven Inner Region

Generally, as shown in FIG. 5, the attachment-driven inner region 126 of the radial profile 114 defines multiple features configured to enable engagement between an attachment subassembly 140 in the set of attachment subassemblies 140 and the disk 108. More specifically, the attachment-driven inner region 126 is configured to resist torsional and vibrational forces caused by the disk 108 during operation as a member of the compound rotor assembly 106. In particular, the attachment-driven inner region 126 defines: a central bore 130 configured to engage with the alignment pin 142 of an attachment subassembly 140; an annular surface 128 concentric with the central bore 130; and a clearance-driven transition 136 circumscribing the annular surface 128. Each of the features defined in the attachment-driven inner region 126 functions to properly engage the disk 108 with the attachment subassembly 140. The central bore 130 is configured to receive the alignment pin 142, the annular surface 128 can include a set of threaded bores that receive a set of disk-flange fasteners 150 to fasten the attachment flange 144 of the attachment subassembly 140 to the disk 108, and the clearance-driven transition 136 connects the outer edge of the annular surface 128 to the Laval-like intermediate region 138 without interfering with inter-flange fasteners 146 that fasten the pair of attachment flanges of the attachment subassembly 140 together. Thus, the attachment-driven inner region 126 defines a set of features that maintains a mechanical connection and axial alignment between disks 108 of the compound rotor assembly 106.

The attachment-driven inner region 126 defines a radial thickness a. Within the attachment-driven inner region 126, the radial thicknesses of the central bore 130, the radial thickness of the annular surface 128, and the radial thickness of the clearance-driven transition 136 are selected based on the expected forces acting on the attachment between the disk 108 and an attachment subassembly 140.

In one implementation, the attachment-driven inner region 126 defines a central bore radius 132 measuring greater than half the radial thickness of the annular surface 128, thereby ensuring sufficient axial support for the compound rotor assembly 106 via an alignment pin 142 inserted into the central bore 130. However, the dimensions of the central bore 130 and annular surface 128 may be selected based on any other design considerations. Additionally, the clearance-driven transition 136 defines a curvature sufficient to provide clearance for the insertion of inter-flange fasteners 146 extending from threaded bores in the attachment flange 144 at the radial position of the inter-flange fasteners 146.

The attachment-drive inner region defines a central bore 130 characterized by a bore depth sufficient to fully support the alignment pin 142 and, therefore, maintain axial alignment of the set of disks 108 in the compound rotor assembly 106. However, the central bore 130 is characterized by a bore depth sufficient to prevent the intersection of the central bore 130 with the internally stressed volume of the disk 108 (e.g., exhibiting an expected stress less than a threshold stress).

The attachment-driven inner region 126 defines the clearance-driven transition 136 that intersects the Laval-like intermediate region 138 and the outer edge of the annular surface 128 to smoothly communicate stress between regions of the disk 108 without undue stress concentrations. In yet another implementation, the attachment-driven inner region 126 defines the clearance-driven transition 136 based on a clearance zone corresponding to the set of fasteners selected as the inter-flange coupling mechanism. In one implementation, the clearance-driven transition 136 is characterized by a clearance depth relative to an adjacent attachment flange 144 in the pair of attachment flanges based on tooling dimensions for the set of inter-flange fasteners 146. For example, the clearance-driven transition 136 defines the clearance depth configured to allow a tool or a portion of the tool associated with the attachment flanges and/or inter-flange fasteners 146 to fit within the clearance depth. Thus, in this implementation, the expected forces on the attachment subassembly 140 drive the selection of the inter-flange fasteners 146, which, in turn, drive the curvature of the clearance-driven transition 136.

### 6.1.3. Laval-Like Intermediate Region

Generally, the Laval-like intermediate region 138 occupies the region of the disk 108 between the attachment-driven inner region 126 and the rim-transitional outer region 116. More specifically, the Laval-like intermediate region 138 is characterized by a substantially isostress radial stress profile (i.e., varying within a threshold stress buffer) between radial positions a and r while the disk 108 is spinning at target operational speeds (e.g., based on finite element analysis). In particular, the Laval-like intermediate region 138 can be approximated by a spline curve, higher-order polynomial (e.g., of order greater than two), or any other suitable function, L(x). In one implementation, the Laval-like intermediate region 138 of the radial profile 114 is represented by a numerically refined function, L_{N}(x), resulting from multiple iterations of a numerical modeling process S100 further described below. Thus, the Laval-like intermediate region 138 bridges the attachment-driven inner region 126 and the rim-transitional outer region 116 while minimizing the amount of material within the Laval-like intermediate region 138, thereby increasing the shape factor of the disk 108.

### 6.2. Numerical Modeling Process

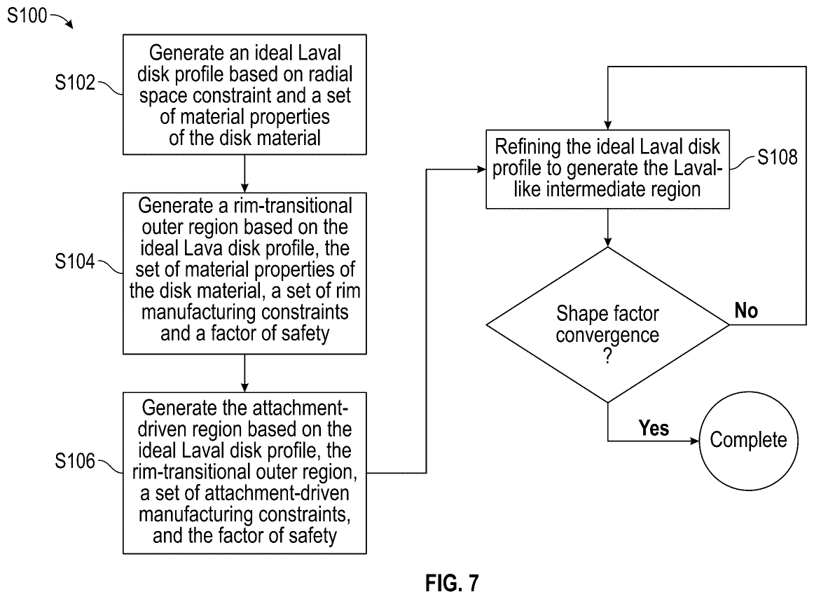

In one variation, as shown in FIG. 7, the radial profile 114 of the disk 108 is generated via a numerical modeling process S100 based on the volumetric constraints of the deployment volume 104 and the compound rotor housing 158 of the compound rotor assembly 106. More specifically, the numerical modeling process S100 includes: generating an ideal Laval disk 108 profile in Step S102, L₀(x), based on a radial space constraint 112 (e.g., defined by a dimension of the deployment volume 104, motor generator unit, and/or compound rotor housing 158), xₘₐₓ, a vector of disk 108 material properties, Pₘ, and a safety factor; generating the rim-transitional region in Step S104, R(x), based on the ideal Laval disk 108 profile, L₀(x), the vector of material properties Pₘ, a vector of manufacturing constraints, Cₘ, and the safety factor; generating the attachment-driven inner region 126 in Step S106, A(x), based on the ideal Laval disk 108 profile, L₀(x), the rim-transitional region, R(x), the vector of material properties Pₘ, a vector of manufacturing constraints, Cₘ, and the safety factor; and iteratively refining the ideal Laval disk 108 profile in Step S108, L₀(x), between the rim-transitional outer region 116, R(x), and the attachment-driven inner region 126, A(x), to generate the Laval-like intermediate region 138, L_{N}(x), via convergence toward a maximum shape factor of the radial profile. Thus, an ideal Laval disk 108 shape for a given radial constraint enables the approximation of an ideal rim-transitional outer region 116 and an ideal attachment-driven inner region 126. Once these approximately ideal regions have been generated, the Laval-like intermediate region 138 may be further refined until convergence on an approximately optimal shape factor for the disk 108.

The numerical modeling process S100 is executed, at least in part, by a computer system executing finite element analysis (hereinafter “FEA”) based on various radial profiles of the disk 108. The computer system can include a single computational device or multiple computational devices executing the numerical modeling process S100 over a local or wide area network.

Generally, the numerical modeling process S100 includes generating an ideal Laval disk 108 profile in Step S102 based on a radial constraint and a vector of material properties to act as a basis for subsequent steps of the numerical modeling process. More specifically, the initial generation of the ideal Laval disk 108 profile provides an initial approximation of the dimensions and mass distribution of the final disk 108, enabling generation of the rim-transitional outer region 116 and, subsequently, the attachment-driven inner region 126. In one implementation, the numerical modeling process S100 utilizes a plane of symmetry parallel to the plane of rotation of the disk 108 to model the top and bottom surfaces of each iteration of the radial profile.

The numerical modeling process S100 can include numerically iterating the ideal Laval disk 108 profile to achieve a substantially constant radial stress profile in a resulting disk 108 of radius xₘₐₓ. More specifically, the numerical modeling process S100 includes FEA shape optimization utilizing a radial isostress profile criterion. The numerical modeling process S100 can include modifying an initial radial profile 114 representing the ideal Laval disk 108, generating a finite element method (hereinafter “FEM”) mesh based on the radial profile, simulating stresses in the FEM mesh, and modifying the initial radial profile 114 representing the ideal Laval disk 108 to converge toward a substantially isostress radial stress profile (e.g., a stress profile with stress variation within a predetermined threshold). However, the numerical modeling process S100 can utilize other shape optimization algorithms to generate an ideal Laval disk 108 profile, such as genetic algorithms, simulated annealing, Delaunay triangulation, Voronoi mesh generation, or any combination thereof.

In one implementation, the numerical modeling process S100 utilizes an additional input indicating a discrete minimum thickness for the outer edge of the ideal Laval disk 108 profile. Upon receiving a discrete minimum disk 108 thickness, yₘᵢₙ, at xₘₐₓ the numerical modeling process S100 can include generating the ideal Laval disk 108 profile via the aforementioned numerical methods with the rim width at xₘₐₓ as an initial condition.

Upon generation of the ideal Laval disk 108 profile, the numerical modeling process S100 includes modifying an outer region of the ideal Laval disk 108 profile to instead define the rim-transitional outer region 116 in Step S102. In one implementation, the numerical modeling process S100 includes applying a predetermined rim profile that satisfies known manufacturing constraints for the disk 108 material to generate R(x). In this implementation, the numerical modeling process S100 can include adjusting the dimensions of the predetermined rim profile based on the dimensions of the ideal Laval disk 108 profile and/or the material properties or manufacturing constraints for the disk 108. Alternatively, the numerical modeling process S100 can include autogeneration of the rim profile (according to methods described above) based on initial manufacturing constraints such as maximum rim thickness 120, maximum radial width, minimum width of the circumferential surface 122, or any other manufacturing constraint. Thus, upon generation of R(x), the resulting radial profile 114 is represented by a piecewise function:

$$\begin{matrix}y = {L}_{0} ( x ) , [ 0 , r ) \\ y = R ( x ) , [ r , {x}_{max} ]\end{matrix}$$

The numerical modeling process S100 can further include generating an attachment-driven inner region 126 of the radial profile 114 in Step S106 based on the ideal Laval disk 108 profile and the rim-transitional outer region 116 of the radial profile. In one implementation, the numerical modeling process S100 includes applying a predetermined attachment profile that satisfies known manufacturing constraints for the disk 108 material to generate A(x). In this implementation, the numerical modeling process S100 can include adjusting the dimensions of the predetermined attachment profile based on the dimensions of the ideal Laval disk 108 profile, the rim-transitional outer region 116, the material properties, and/or manufacturing constraints for the disk 108. Alternatively, the numerical modeling process S100 can include autogeneration of the attachment profile (according to methods described above) based on initial manufacturing constraints such as maximum annular surface radial width, a minimum central bore depth, a maximum central bore depth, dimensions of the alignment pin 142 of the attachment subassembly 140, dimensions of the attachment flange, dimensions of the inter-flange fasteners 146, dimensions of the disk-flange fasteners 150, dimensions of tooling corresponding to the inter-flange fasteners 146, or any other manufacturing constraint. Additionally, the numerical modeling process S100 can include selecting or setting any of the aforementioned manufacturing constraints based on L₀(x), [0, r), and R(x), [r, xₘₐₓ]. Thus, upon generation of A(x), the resulting radial profile 114 is represented by the piecewise function:

$$\begin{matrix}y = A ( x ) , [ 0 , a ] \\ y = {L}_{0} ( x ) , ( a , r ) \\ y = R ( x ) , [ r , {x}_{max} ]\end{matrix}$$

Upon generation of both R(x) and A(x) based on the naive isostress profile of L₀(x), the numerical modeling process S100 includes refining the Laval-like intermediate region 138 in Step S108 to account for the changes to the radial profile 114 between x=0 and a and between r and xₘₐₓ. More specifically, the numerical modeling process S100 can include utilizing any of the numerical methods described above to refine parameters defining the Laval-like intermediate region 138. In implementations in which the Laval-like intermediate region 138 is represented as a spline curve or piecewise polynomial function, the numerical modeling process S100 can include numerically modifying spline points and/or intersections within the Laval-like intermediate region 138 based on estimated stresses on the disk 108 during rotation at operational angular velocities. In implementations in which the Laval-like intermediate region 138 is represented as a higher-order polynomial, the numerical modeling process S100 can include numerically modifying terms of the polynomial based on estimated stresses on the disk 108 during rotation at operational angular velocities. The numerical modeling process S100 can include iteratively regenerating the Laval-like intermediate region 138 until the iterations of the radial profile 114 converge toward a maximum shape factor. Thus, upon generating the Laval-like intermediate region 138, the radial profile 114 of the disk 108 is represented by the piecewise function:

$$\begin{matrix}y = A ( x ) , [ 0 , a ] \\ y = {L}_{N} ( x ) , ( a , r ) \\ y = R ( x ) , [ r , {x}_{max} ]\end{matrix}$$

where N represents the number of iterations of the Laval-like intermediate region 138 prior to convergence toward the maximum shape factor.

### 7. Attachment Subassemblies

As shown in FIGS. 3 and 6, the compound rotor assembly 106 includes a set of attachment subassemblies 140 between each adjacent pair of disks 108. More specifically, each attachment subassembly 140 includes: an alignment pin; a pair of attachment flanges (corresponding to each of the adjacent disks 108); a set of disk-flange fasteners 150 configured to fasten each attachment flange 144 to an adjacent disk 108 in the pair of adjacent disks 108; and a set of inter-flange fasteners 146 configured to fasten the pair of attachment flanges together.

In particular, the tension of the disk-flange fasteners 150 engages a disk-facing surface of the attachment flange 144 with the annular surface 128 of the disk 108, thereby enabling the transfer of torque between the disk 108 and the attachment subassembly 140. Likewise, the inter-flange fasteners 146 are tensioned to engage the flange-facing surface of the fastener with the flange-facing surface of the opposite attachment flange 144 in the pair of attachment flanges.

Additionally, the alignment pin 142 is positioned within the central bore 130 of each of the pair of adjacent disks 108 and passes through the center of the attachment subassembly 140 to axially align the pair of adjacent disks 108 and the pair of attachment flanges 144. Thus, each attachment subassembly 140 in the set of attachment subassemblies 140 transfers torque between each pair of adjacent disks 108 of the compound rotor assembly 106, axially aligns each disk 108 of the compound rotor assembly 106, and prevents degradation of the compound rotor assembly 106 due to vibrational forces.

### 7.1. Alignment Pin

Generally, as shown in FIG. 3, the attachment subassembly 140 includes an alignment pin 142 characterized by a radius less than the central bore radius 132 of each disk 108 in the set of disks 108 by a clearance margin (e.g., less than 0.1 mm). The alignment pin 142 is configured to: arrange within a pair of adjacent central bores 130 of the pair of adjacent disks 108; and maintain a position of each disk 108 of the pair of adjacent disks 108 relative to the opposite adjacent disk 108. More specifically, the alignment pin 142 is substantially cylindrical in shape with filets or chamfers on the circular edges to facilitate insertion into the adjacent central bores 130 of a pair of adjacent disks 108. The alignment pin 142 functions to axially align adjacent disks 108 via contact between the inner surface of the central bores 130 of the pair of adjacent disks 108 and the outer surface of the alignment pin. The alignment pin 142 can be constructed from a rigid isotropic material similar to the set of disks 108 and can be cast, machined, and heat treated in a similar manner to the set of disks 108 to ensure commensurate mechanical properties with the disk 108.

Due to a tight clearance between the alignment pin 142 and the central bore 130 and the high mass of the alignment pin, the alignment pin 142 can define a threaded-through bore 152 to facilitate disassembly of the compound rotor assembly 106 by enabling removal of the alignment pin 142 from a central bore 130 of a disk 108. In this implementation, a threaded bolt can be inserted into the threaded through-bore 152 and rotated to cause the alignment pin 142 to extricate from the central bore 130 of the disk 108. Thus, the alignment pin 142 is configured for removal from adjacent disks 108 without risking damage to the disk 108 or alignment pin 142 due to the use of clamping mechanisms or other means of extraction.

### 7.2. Pair of Attachment Flanges

Generally, as shown in FIGS. 3 and 6, each attachment subassembly 140 includes a pair of attachment flanges located between the pair of adjacent disks 108. Each attachment flange 144 in the pair of attachment flanges corresponds to a disk 108 in the pair of adjacent disks 108. More specifically, each attachment flange 144 defines: an inner radius approximately equal to the radius of the central bore 130 to enable the attachment flange 144 to fit around the alignment pin; and an outer radius sufficient to structurally support a radial arrangement of disk-flange fasteners 150 driven through the attachment flange 144 and into the annular surface 128 of an adjacent disk 108 and a radial arrangement of inter-flange fasteners 146 (circumscribing the radial arrangement of disk-flange fasteners 150) driven through the attachment flange 144 into an opposite attachment flange 144 in the pair of attachment flanges. In one implementation, each attachment flange 144 can include: a set of inter-flange fastener bores 148 (optionally threaded) configured to receive a set of interflange fasteners; and a set of disk-flange fastener bores 154 (optionally threaded) configured to receive a set of disk-flange fasteners 150. Thus, each attachment flange 144 is fastened to an adjacent disk 108 at one surface and an opposite attachment flange 144 on the other, thereby transferring torque between the pair of adjacent disks 108.

Generally, the number, dimensions, material, and grade of threaded holes and corresponding bolts included in the set of disk-flange fasteners 150 and/or the set of inter-flange fasteners 146 are selected based on the magnitude of the forces expected to be transferred between the disk 108 when accelerated or decelerated by a motor-generator unit 156 during operation plus a factor of safety applied to the expected torque. Thus, the set of disk-flange fasteners 150 and the set of inter-flange fasteners 146 can include any number of screws or bolts as necessary to apply a sufficient normal force to the annular surface 128 of the disk 108 and the upper and lower surfaces of the attachment flanges.

### 8. Compound Rotor Configuration

Generally, the compound rotor assembly 106 includes a set of disks 108 and a set of attachment subassemblies 140 between each pair of adjacent disks 108. For example, the set of disks 108 can include two to eight disks 108 depending on the implementation, and the set of attachment subassemblies 140 can include one to seven attachment subassemblies 140 respectively. However, in one implementation, the number of disks 108 in the set of disks 108 and the number of attachment subassemblies 140 in the set of attachment subassemblies 140 can be selected based on a total axial space constraint, yₜₒₜₐₗ, for the compound rotor assembly 106. In this implementation, the compound rotor assembly 106 includes a number of disks 108 and a number of attachment subassemblies 140 based on the axial thickness of each disk 108 in the set of disks 108, yₐₓᵢₐₗ, which can be calculated based on the numerical modeling process S100 described above, and the axial length, yₚᵢₙ of the set of alignment pins 142. Thus, in implementations for each disk 108 in the set of disks 108 are characterized by the same radial profile (and therefore the same yₐₓᵢₐₗ), the number of disks 108, M, and the number of attachment subassemblies 140, M−1, can be selected by calculating the maximum M∈N that satisfies the following inequality:

$${My}_{axial} + ( M - 1 ) {y}_{pin} < {y}_{total}$$

The compound rotor assembly 106 can, therefore, include a number of disks 108 and a number of attachment subassemblies 140 based on yₐₓᵢₐₗ and yₚᵢₙ, which are selected or derived based on the radial profile 114 of each disk 108, which, in turn, can be derived from the radial space constraint 112, xₘₐₓ. Thus, the number of disks 108 in the set of disks 108 and the number of attachment subassemblies 140 in the set of attachment subassemblies 140 are selected based on the radial space constraint 112, xₘₐₓ, the axial space constraint, yₜₒₜₐₗ, the vector of mechanical properties, Pₘ, and the vector of manufacturing constraints Cₘ.

In one implementation, the radial space constraint 112 and axial space constraint of the compound rotor assembly 106 are defined based on dimensions of the deployment volume 104 (less the space of other components within the deployment volume 104, such as bearings, a motor-generator unit, and a compound rotor housing 158). For example, for a standard shipping container (20 feet by 8 feet by 8.5 feet) system housing 102, the axial (e.g., shipping container height) and radial (e.g., shipping container width) space constraints enable one implementation of the system 100 that includes a compound rotor assembly 106 with a set of three disks 108 and a set of two attachment subassemblies 140. In this implementation of the compound rotor assembly 106, the disk radius 110 can be selected for two instances of the compound rotor assembly 106 to be arranged within the standard shipping container. Thus, in this implementation, the system 100 including two compound rotor assemblies 106 can be deployed to a target site within a standard shipping container, thereby reducing the deployment costs of the system.

Generally, the disk radius 110 is constrained by at least the radial space constraint 112. For example, the radial space constraint 112 can be based on one or more of: a thickness of the disk 108; a width of a deployment volume 104 housing the disk 108; and a number of disks 108 and an arrangement of the number of disks 108 within the deployment volume 104. The radial profile 114 of the disk 108 links the thickness of the disk 108 to the disk radius 110, such that a chosen disk 108 thickness determines a disk radius 110 or a range of possible disk radii. The width of the deployment volume 104 sets an upper bound on the radius of the disk 108, such that the disk 108 can fit within the system housing 102. In one implementation, the arrangement of the number of disks 108 within the deployment volume 104 defines a pattern of placements of compound rotor assemblies 106 within the deployment volume 104. For example, the arrangement can correspond to a two-by-three pattern of compound rotor assemblies 106 placed within the deployment volume 104. Therefore, the arrangement of this example constrains the disk radius 110 to less than a third of the deployment volume 104 length and less than half of the deployment volume 104 width to enable the two-by-three pattern.

In one implementation, the disk radius 110 can be further constrained by a radial space constraint based on the width of the motor generator unit and/or the compound rotor housing 158. For example, the width of the motor-generator unit can set a lower bound on the disk radius, while the interior width of the compound rotor housing defines an upper bound of the disk radius 110. In one implementation, the disk radius is selected to arrange the disk 108 within the compound rotor housing while allowing for a clearance between the edge of the disk 108 and the interior surface of the compound rotor housing 158.

Generally, the number of disks 108 in the set of disks 108 of the compound rotor assembly 106 is constrained by at least the axial space constraint. In one implementation, the number of disks 108 in the set of disks 108 is selected based on: an axial space constraint defined by a height of the deployment volume 104; an axial thickness of each disk 108 in the set of disks 108; and an axial thickness of each attachment subassembly 140 in the set of attachment subassemblies 140. For example, for a system housing 102 defining a height of 8 feet, the axial constraint for the number of disks 108 is 8 feet less the axial dimensions of additional components of the system 100 (e.g., bearings, motor-generator unit, compound rotor housing 158) and necessary clearances between those components. Therefore, the number of disks 108 can be selected according to the thickness of each disk 108, a number of attachment assemblies within the compound rotor assembly 106 (e.g., M−1, where M is the number of disks 108), and a thickness of the attachment assemblies. Thus, the disk 108 thickness and number of disks 108 per compound rotor assembly 106 can be selected to maximize a number of disks 108 per compound rotor assembly 106 that fits within the axial constraint (e.g., the deployment volume height) less the axial dimensions and clearances of the additional components.

In one implementation: the disk radius 110 is constrained by a radial space constraint 112; the disk 108 thickness is constrained by one or more of the disk radius 110, and an attachment-driven constraint; and the number of disks 108 in the set of disks 108 of each compound rotor assembly 106 is selected based on one or more of the disk 108 thickness, an attachment flange 144 thickness, and a height of the deployment volume 104. For example, the disk radius 110 can be selected based on the interior width and length of the system housing 102, and the disk 108 thickness can be selected from a range of disk 108 thicknesses associated with the disk radius 110 that fulfill the requirements of the radial profile. Further, the attachment-driven constraint can define a thickness of the pair of attachment flanges between each pair of adjacent discs and/or a minimal disk 108 clearance between to accommodate the attachment subassembly 140.

### 9. Storage Capacity-Driven Example Implementation

Generally, the system 100 can be configured with a different number of compound rotor assemblies 106, disk radii 110, and number of disks 108 per compound rotor assembly 106, such as to customize the system 100 for an application. In one implementation, the system 100 can be used to store energy and provide energy in the case of a power outage or a grid brownout. In this implementation, the system 100 is configured to maximize storage capacity, such as via maximizing the disk radii based on the dimensions of the deployment volume 104 (e.g., in this implementation, the disk radii and therefore the energy storage capacity are constrained by the radial space constraint 112 set by the dimensions of the system housing 102).

For example, as shown in FIG. 2, a storage capacity-driven implementation within a standard shipping container can include: two compound rotor assemblies 106 arranged within the deployment volume 104 of the system housing 102; and three disks 108 vertically arranged within each compound rotor assembly 106. In this implementation, the set of disks 108 includes an upper disk 108, a middle disk 108, and a lower disk 108. In this implementation, the disk radius 110 is constrained by a radial space constraint 112 based on one or more of a width of the deployment volume 104, and a length of the deployment volume 104. In this example, the radius of each disk 108 of the system 100 is constrained to be less than 4 feet due to the shipping container width of 8 feet and a minimum clearance between the disk 108 and a wall of the shipping container. Due to the disk radius 110, no more than two compound rotor assemblies 106 featuring these disks 108 can fit within the 20-foot length of the shipping container. Practically, the disk radius 110 of this implementation may be approximately 3 feet to allow space for a compound rotor housing 158 around the disks 108 and a clearance between the disk 108 and the compound rotor housing 158 that accommodates any possible oscillation of the disk 108.

### 10. Throughput-Driven Example Implementation

Another implementation of the system, as shown in FIG. 1, can be configured to maximize a throughput of the system (e.g., minimize the charging and discharging rates). This implementation of the system can be used such as to provide power smoothing for a data center running an artificial intelligence model. For example, the data center may exert sudden and irregular load increases on the grid due to initiation of artificial intelligence models or queries. The irregular loads and peaks of AI workloads can induce transients on the grid that destabilize existing power infrastructure. However, the throughput-driven implementation of the system 100 can be connected to the power supply of the data center, such as between the grid and the data center, to provide active power conditioning. Therefore, this implementation of the system 100 can provide the demanded power to the data center within milliseconds during demand surges rather than destabilizing the grid with the irregular load.

This implementation can also be used to replace a synchronous condenser of the grid. The throughput-driven implementation can provide low-latency power conditioning to the grid to smooth grid loads and/or isolate loads to reduce stress on the grid by absorbing sudden power influxes and/or dispersing power to smooth grid sags.

For example, as shown in FIG. 1, a throughput-driven implementation can include: a set of ten compound rotor assemblies 106 arranged in a two-by-five arrangement within the deployment volume 104 of the system housing 102; and a set of disks 108 within each compound rotor assembly 106 including eight vertically arranged disks 108. In this implementation, the disk radius 110 is constrained by a radial space constraint 112 based on one or more of: the two-by-five arrangement; a width of the motor-generator unit; a width of the deployment volume 104; and a thickness and/or width of the compound rotor housing 158. The two-by-five arrangement of the compound rotor assemblies 106 constrains the width of the compound motor assembly housing to less than one-half of the deployment volume width and less than one-fifth of the deployment volume length. For a system in a standard shipping container (20 feet in length, by 8 feet in width, by 8.5 feet in height), each compound rotor housing 158 is constrained to less than four feet in diameter by the width of the deployment volume 104, the length of the deployment volume 104, and the two-by-five arrangement. Therefore, each disk 108 within the compound rotor housing 158 is constrained to a less than two feet radius to fit within the less than four feet wide compound rotor housing 158. In some implementations, the width of the motor-generator unit 156 constrains the disk radius 110. For example, the width of the motor-generator unit 156 may define a lower bound of the disk radius 110.

However, the system 100 can include any other combination of housing dimensions, disk radii, disks 108 per compound rotor assembly 106, and number of compound rotor assemblies 106, based on the target application of the system.

### ADDITIONAL CONSIDERATIONS

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented, at least in part, as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system comprising:
a system housing defining a deployment volume;
a set of compound rotor assemblies, arranged within the deployment volume, each compound rotor assembly comprising:
a set of disks, wherein each disk in the set of disks is substantially coaxial, rotationally symmetric, monolithic, and characterized by:
a disk radius; and
a radial profile comprising:
a rim-transitional outer region defining:
a circumferential rim about the circumference of the disk characterized by a rim thickness and a circumferential surface; and
a rim transition inscribing the circumferential rim;
an attachment-driven inner region defining:
an annular surface substantially concentric with a central bore and substantially parallel to a rotational plane of the disk, the central bore characterized by a central bore radius and a central bore depth relative to the annular surface; and
a clearance-driven transition circumscribing the annular surface; and
a Laval-like intermediate region connecting the clearance-driven transition to the rim transition; and
between each pair of adjacent disks in the set of disks, an attachment subassembly in a set of attachment subassemblies, each attachment subassembly comprising:
an alignment pin arranged within a pair of adjacent central bores of the pair of adjacent disks; and
a pair of attachment flanges circumscribing the alignment pin, each attachment flange in the pair of attachment flanges fastened to an opposite attachment flange in the pair of attachment flanges via a set of inter-flange fasteners and fastened to a disk in the pair of adjacent disks via a set of disk-flange fasteners; and
a set of motor-generator units, each motor-generator unit in the set of motor-generator units:
coupled to a compound rotor assembly in the set of compound rotor assemblies; and
configured to transmit and extract rotational energy from the compound rotor assembly.

2. The system of claim 1 wherein:
the set of compound rotor assemblies comprises ten compound rotor assemblies arranged in a two-by-five arrangement within the deployment volume of the system housing;
the set of disks of each compound rotor assembly in the set of compound rotor assemblies comprises eight vertically arranged disks; and
the disk radius is constrained by a radial space constraint based on one or more of:
the two-by-five arrangement;
a width of the motor-generator unit; and
a width of the deployment volume.

3. The system of claim 1 wherein:
the set of compound rotor assemblies comprises two compound rotor assemblies arranged within the deployment volume of the system housing;
the set of disks of each compound rotor assembly in the set of compound rotor assemblies comprises three vertically arranged disks; and
the disk radius is constrained by a radial space constraint based on one or more of:
a width of the deployment volume; and
a length of the deployment volume.

4. The system of claim 1, wherein a number of disks in the set of disks is selected based on:
an axial space constraint defined by a height of the deployment volume;
an axial thickness of each disk in the set of disks; and
an axial thickness of each attachment subassembly in the set of attachment subassemblies.

5. The system of claim 1, wherein:
the disk radius is constrained by a radial space constraint;
a disk thickness is constrained by one or more of the disk radius, an attachment-driven and constraint; and
a number of disks in the set of disks of each compound rotor assembly is selected based on one or more of the disk thickness, an attachment flange thickness, and a height of the deployment volume.

6. A compound rotor assembly comprising:
a set of disks, wherein each disk in the set of disks is substantially coaxial, rotationally symmetric, monolithic, and characterized by a radial profile comprising:
a rim-transitional outer region defining:
a circumferential rim about the circumference of the disk characterized by a rim thickness and a circumferential surface; and
a rim transition inscribing the circumferential rim;
an attachment-driven inner region defining:
an annular surface substantially concentric with a central bore and substantially parallel to a rotational plane of the disk, the central bore characterized by a central bore radius and a central bore depth relative to the annular surface; and
a clearance-driven transition circumscribing the annular surface; and
a Laval-like intermediate region connecting the clearance-driven transition to the rim transition; and
between each pair of adjacent disks in the set of disks, an attachment subassembly in a set of attachment subassemblies, each attachment subassembly comprising:
an alignment pin arranged within a pair of adjacent central bores of the pair of adjacent disks; and
a pair of attachment flanges circumscribing the alignment pin, each attachment flange in the pair of attachment flanges fastened to an opposite attachment flange in the pair of attachment flanges via a set of inter-flange fasteners and fastened to a disk in the pair of adjacent disks via a set of disk-flange fasteners.

7. The compound rotor assembly of claim 6, wherein the set of disks comprises:
an upper disk;
a middle disk; and
a lower disk.

8. The compound rotor assembly of claim 6, wherein each attachment subassembly in the set of attachment subassemblies comprises the alignment pin defining a threaded axial through-bore.

9. The compound rotor assembly of claim 6, wherein, for each disk in the set of disks, the clearance-driven transition is characterized by a clearance depth relative to an adjacent attachment flange in the pair of attachment flanges based on tooling dimensions for the set of inter-flange fasteners.

10. A flywheel disk characterized by a radial profile comprising:
a disk radius;
a rim-transitional outer region defining:
a circumferential rim about the circumference of the disk characterized by a rim thickness and a circumferential surface; and
a rim transition inscribing the circumferential rim;
an attachment-driven inner region defining:
an annular surface substantially concentric with a central bore and substantially parallel to a rotational plane of the disk, the central bore characterized by a central bore radius and a central bore depth relative to the annular surface;
a set of disk-flange fastener bores arranged radially about the central bore, each disk-flange fastener bore in the set of disk-flange fastener bores configured to receive a disk-flange fastener;
a clearance-driven transition circumscribing the annular surface; and
a Laval-like intermediate region connecting the clearance-driven transition to the rim transition.

11. The flywheel disk of claim 10, wherein the disk radius is constrained by a radial space constraint based on one or more of:
a thickness of the disk;
a width of a deployment volume housing the disk; and
a number of disks and an arrangement of the number of disks within the deployment volume.

12. The flywheel disk of claim 10, wherein the clearance-driven transition is characterized by a clearance depth relative to an adjacent attachment flange in the pair of attachment flanges based on tooling dimensions for the set of inter-flange fasteners.

13. The flywheel disk of claim 10, wherein the Laval-like intermediate region is configured to maintain an approximate isostress radial stress profile within the Laval-like intermediate region based on finite element analysis.

14. The flywheel disk of claim 10, wherein the Laval-like intermediate region is characterized by a numerically refined spline curve based on material properties of the disk and a radial space constraint of the disk.

15. The flywheel disk of claim 10, wherein the Laval-like intermediate region is characterized by a numerically refined polynomial of an order greater than two based on material properties of the disk and a radial space constraint of the disk.

16. The flywheel disk of claim 10, wherein each disk in the set of disks is symmetric about a plane of symmetry parallel to the rotational plane.

17. The flywheel disk of claim 10, wherein the disk is characterized by a shape factor greater than 0.7.

18. The flywheel disk of claim 10, wherein the disk consists of an isotropic material.

19. The flywheel disk of claim 10, wherein the disk consists essentially of a high-strength steel.

20. The flywheel disk of claim 10, wherein the disk is rotationally balanced via selective machining of the circumferential surface of the rim.
